(19) United States
(12) Patent Application Publication
(10) Pub. No.: US 2026/0213367 A1
(43) Pub. Date: Jul. 23, 2026

(54) SECONDARY CELL

(71) Applicant: Northvolt AB, Stockholm (SE)

(72) Inventor: Kenya Shatani, Stockholm (SE)

(21) Appl. No.: 19/142,210

(22) PCT Filed: Dec. 20, 2023
(86) PCT No.: PCT/EP2023/086869

§ 371 Date: Jun. 22, 2025

(30) Foreign Application Priority Data
Dec. 23, 2022 (SE) 2251578-7

(51) Int. Cl. H01M 50/533; H01M 10/0587; H01M 50/107; H01M 50/152; H01M 50/169; H01M 50/536

(52) U.S. Cl. CPC H01M 50/533; H01M 10/0587; H01M 50/107; H01M 50/152; H01M 50/169; H01M 50/536

(57) ABSTRACT

A cylindrical secondary cell (10), comprising a cylindrical enclosure (11) having a sidewall (10c) and at least one open end (10b), an electrode roll (20) arranged in the cylindrical enclosure (11), a lid (1) closing the open end (10b) of the cylindrical enclosure (11), the lid (1) being welded to the cylindrical enclosure (11) at a first location (23), and a current collector disc (15) arranged between the electrode roll (20) and the lid (1) and in direct electrical contact with the electrode roll (20), the current collector disc (15) being welded to the cylindrical enclosure (11) at a second location (24) separate to the first location (23).

### TECHNICAL FIELD

The present disclosure generally pertains to cylindrical secondary cells and more precisely to a cylindrical secondary cell comprising a lid and a current collector disc arranged at separate locations in said cell.

### BACKGROUND

In addressing climate change, there is an increasing demand for rechargeable batteries, e.g. to enable electrification of transportation and to supplement renewable energy. Currently, lithium-ion batteries are becoming increasingly popular. They represent a type of rechargeable battery in which lithium ions move from the negative electrode to the positive electrode during discharge and back when charging.

As the demand for rechargeable batteries increases, more and more focus is being placed on production speed and cost. To achieve an effective production of rechargeable batteries, the design of the batteries as well as their manufacturing process can be optimized.

### SUMMARY

In view of the above considerations, there is provided, according to aspects of the present disclosure, a welding arrangement for a lid and a current collector disc of a secondary cell.

In particular, according to one aspect of the present disclosure, there is provided a cylindrical secondary cell (also referred to herein as a ‘secondary cell’ or simply ‘cell’) comprising a cylindrical enclosure having a sidewall and at least one open end, an electrode roll arranged in the cylindrical enclosure. The cell further comprises a lid closing the open end of the cylindrical enclosure, the lid being welded to the cylindrical enclosure at a first location, and a current collector disc arranged between the electrode roll and the lid. The current collector disc is arranged in direct electrical contact with the electrode roll, and is welded to the cylindrical enclosure at a second location separate to the first location.

There are a number of advantages associated such an approach, one of them being that the lid and the current collector disc can be secured in their position during the manufacturing process. Since both the lid and the current collector disc are attached to the cylindrical enclosure by welding, the same manufacturing method can be used for both attaching the lid and the current collector. This is advantageous in that the number of manufacturing methods needed to produce a cell may be decreased.

Another advantage associated with the present disclosure is that attaching the lid and the current collector separately may facilitate positioning of the lid and the current collector disc. Further, it may facilitate welding the two parts to the cylindrical enclosure. There is only one interface needed, that between the part (lid or current collector disc) and the cylindrical enclosure. This means that less consideration is needed to be taken in view of tolerance, since the lid and the current collector disc does not need to be oriented to match each other, or the measurements of the lid and the current collector does not necessarily have to coincide. The lid and the current collector disc may thus be seen as independent parts. This is advantageous in that it increases the number of design choices for the cell. For example, different designs of the lid and current collector disc may be used in the cell since they do not have to match each other. Furthermore, the lid and the current collector disc does not need to be aligned with each other in order to be properly positioned in the cylindrical enclosure. This is advantageous in that the lid and the current collector disc only need to be aligned with the cylindrical enclosure for positioning, which facilitates assembling of the cell.

Furthermore, the present disclosure may enable a shorter current path from the current collector disc to the cylindrical enclosure. In the case where the lid is attached to the current collector disc, the current path goes from the current collector, through the lid and to the cylindrical enclosure. In the present disclosure, since the lid and the current collector disc are welded separately to the cylindrical enclosure, the current path does not have to go through the lid, resulting in it being shorter.

In some examples, the lid or the current collector disc comprises a number of recessed contact portions being 50 to 80 percent of the total area of the lid. An advantage with the above is that the recessed contact portions allow for facilitated electrolyte filling. The recessed contact portions provide a space for the electrolyte to flow in. Further, the recessed contact portions preferably have an area covering a majority of the total area of the lid or the current collector disc.

The recessed contact portions may be generally trapezoid in shape, or may have the shape of a truncated annulus. The cylindrical secondary cell may comprise both a positive terminal and a negative terminal at one and the same end. The lid may be arranged in direct electrical contact with an enclosure of the cylindrical secondary cell. The cylindrical enclosure may act as the negative terminal.

In the case where the recessed contact portions are on the lid, the recessed contact portions can provide mechanical support to the lid, increasing its stability during normal operation of the cell. Further, the recessed contact portions can provide an increased stability in the case of a crash event or other failure. The recessed contact portions may for example provide stability in terms of deformation of the lid, preventing or mitigating a deformation of the cell during a crash event. Furthermore, the cell itself may become more stable comprising a lid with recessed contact portions.

Simultaneously, the recessed contact portions may also provide features for gripping or in other ways physically handling the cell, since the recessed contact portions provides structural features to the lid. For example, in comparison to a case where the lid is substantially flat, there are less structural features to utilize when moving the cell, or similar. The present disclosure is therefore advantageous in that the recessed contact portions facilitate handling of the cell.

In another example, the recessed contact portions are on the current collector disc, the recessed contact portions can provide an electrical contact with the electrode roll. The recessed contact portions may be the only part of the current collector disc that is in electrical connection with the conductive sheet on the electrode roll.

The size of the electrical connection area increases with an increased size of the recessed contact portions. Further, the recessed contact portions can provide mechanical support to the current collector disc, increasing its stability in the case of a crash event or other failure. The recessed contact portions may for example provide stability in terms of deformation of the current collector disc, preventing or mitigating a rupture of the electrode roll during a crash event.

In one example, the lid and the current collector disc extend substantially in parallel. This is advantageous in that the parallel placement of the lid and the current collector disc allows for a space being formed between the lid and the current collector, further allowing for electrolyte flow. The lid and the current collector may also have substantially the same shape and size. The shape of the lid and/or the current collector disc may match with a shape of the cylindrical enclosure. For example, the lid and the current collector disc may have a circular shape.

Furthermore, the first location and the second location are axially spaced from each other. Thus, the lid and the current collector disc may be axially spaced from each other in the cylindrical enclosure. This further means that the lid and the current collector disc may be positioned in the cylindrical enclosure independent from each other and with no contact.

In another example, the lid further comprises a first flange to be arranged in direct electrical contact with the cylindrical enclosure of the cylindrical secondary cell. For example, the lid may be substantially circular in shape, and the flange arranged circumferentially around the edge of the lid.

In a further example, the current collector disc comprises a second flange to be arranged in direct electrical contact with the cylindrical enclosure of the cylindrical secondary cell.

In a further example, the lid is configured to be attached to the cylindrical enclosure solely by a welding between the first flange and the cylindrical enclosure. The weld may be done from an outside of the cylindrical enclosure. The area of the flange may be the weld interface. The second flange of the current collector disc may be attached to the cylindrical enclosure by welding between the second flange and the cylindrical enclosure.

The first flange and the cylindrical enclosure extend substantially in parallel. The substantially parallel surfaces of the flange and the cylindrical enclosure may provide a welding surface. The parallel surfaces may facilitate welding, since the distance between the surface of the flanges and the surface of the cylindrical enclosure may be equal over the surfaces.

In another example, a weld interface between the cylindrical enclosure and the lid, after welding, is at least partly visible such that the weld may be inspected. This is advantageous in that it increases the chances of noticing production damages during manufacturing. When the weld interface is visible, the damaged cells can be discarded before use, decreasing the risk of battery malfunction during use.

In one example, the number of recessed contact portions are on the current collecting disc. The number of recessed contact portions are arranged in direct electrical contact with the electrode roll arranged inside the cylindrical secondary cell. The current collector disc may be welded through the number of recessed contact portions to the electrode roll. The current collector disc may be arranged in the cylindrical enclosure through the attachment of the current collector disc to the electrode roll.

According to an aspect of the present disclosure, a method of manufacturing a cylindrical secondary cell is provided. The method comprises arranging the current collector disc in direct electrical contact with the electrode roll, welding the current collecting disc to the cylindrical enclosure, arranging the lid in the cylindrical enclosure, and welding the lid to the cylindrical enclosure.

### BRIEF DESCRIPTION OF THE DRAWINGS

Aspects of the present disclosure will be described, by way of example only, and with reference to the following figures, in which:

FIG. 1 shows a cross-sectional view of an example cylindrical secondary cell lid wherein a lid and a current collector disc are attached to a cylindrical enclosure;

FIGS. 2a-b shows cross-sectional views of a portion of an example cylindrical secondary cell wherein a lid and a current collector disc are attached to a cylindrical enclosure;

FIG. 3 shows a perspective view of a lid with recessed contact portions;

### DETAILED DESCRIPTION

The present disclosure is described in the following way by way of a number of illustrative examples. It will be appreciated that these examples are provided for illustration and explanation only and are not intended to be limiting on the scope of the disclosure.

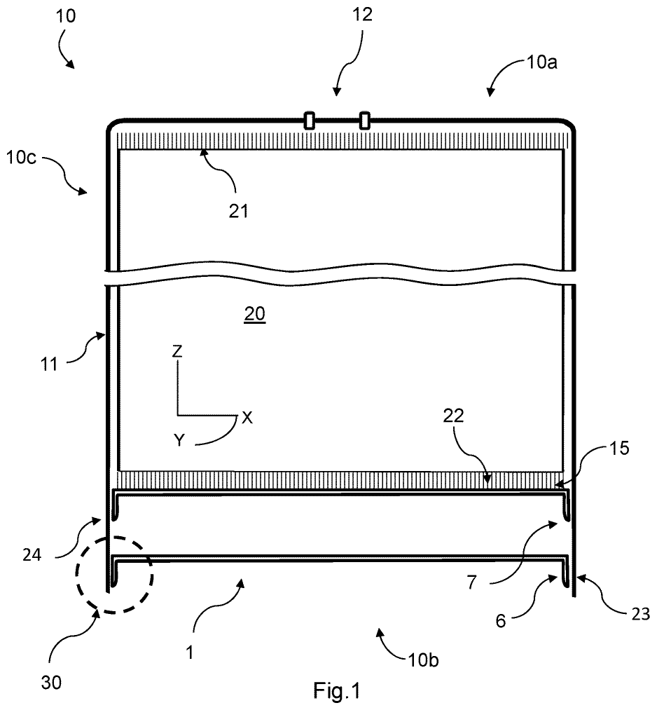

FIG. 1 shows a cross-sectional view of an example cylindrical secondary cell 10 (hereinafter referred to as cell), wherein a lid 1 and a current collector disc 15 are arranged. In the example shown in FIG. 1, the cell 10 is circular cylindrical. The cell 10 comprises a cylindrical enclosure 11 having a first enclosure end 10a, an opposite second enclosure end 10b and an enclosure sidewall 10c that extends between the enclosure ends 10a, 10b. The lid 1 and the current collector disc 15 are attached to a cylindrical enclosure 11.

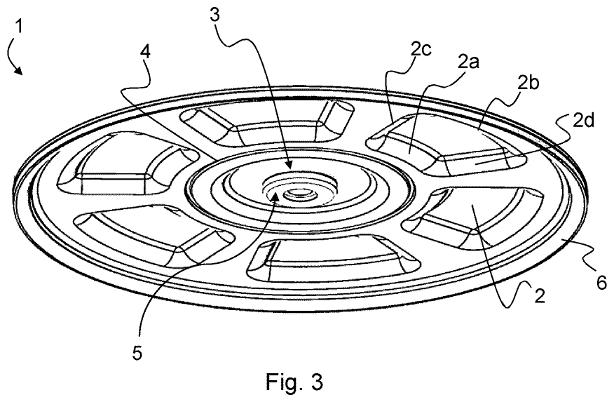

In the exemplified embodiment, the first and second enclosure ends 10a, 10b are circular. The enclosure sidewall 10c is circular cylindrical. The cell 10, and thus its enclosure sidewall 10c, may be elongate and extend along a longitudinal axis (Z-axis in FIG. 1). The enclosure ends 10a, 10b may extend in planes (XY-planes in FIG. 3) that are perpendicular to the longitudinal axis.

As is illustrated, the first enclosure end 10a, may be formed in one piece with the enclosure sidewall 1-c. The second enclosure end 10b can be open, or a separate lid 1 can, as shown in the exemplifying figure, be attached to the cylindrical enclosure at the open enclosure end 10b. Thus, the lid 1 may form the second enclosure end 10b. Alternatively, both the first enclosure end 10a and the second enclosure end 10b may be formed by respective lids.

The cell 10 of FIG. 1 may be of a type that has both a positive terminal and a negative terminal at the same end 10a of the cylindrical secondary cell 10. The first enclosure end 10a comprises a central terminal through-hole 12 for the positive terminal (not shown). The negative terminal may be comprised by the cylindrical enclosure 11.

A cell 10 having both terminals at one end/having the cylindrical enclosure 11 as a terminal may bring advantages as regards electrically connecting the cell to a load. Conductors electrically connecting the terminals to the load may be positioned on the same end, the first enclosure end 10a, of the cell. The opposite end, referred to as the second enclosure end 10b, of the cell 10 may be dedicated to electrolyte filling and venting. An overpressure may be generated within the cell during operation, in particular upon malfunction of the cell or of the load connected to the cell. Such malfunction may require a release of gas and/or other ejecta out of the cell, and it may be advantageous to direct the released gas and/or other ejecta away from the conductors, i.e. out from the second enclosure end 10b, that is opposite to the first enclosure end 10a.

A number of cells 10 may be positioned close to the bottom of an electric vehicle. The cells 10 may be arranged with the first enclosure ends 10a directed away from the ground and the second enclosure ends 10b directed towards the ground. Upon malfunction, for example resulting from a faulty electric vehicle charger or a faulty cell 10, a release of gas and/or other ejecta from the second enclosure ends 10b will be advantageously directed downwards towards the ground beneath the vehicle. In other applications than vehicles, the second enclosure ends 10b may be directed towards a desired location such that any gas and/or other ejecta will not cause damages or injuries.

As is illustrated in FIG. 1, the cell 10 comprises an electrode roll 20. The electrode roll 20 comprises a first and a second conductive sheet 21, 22 and separating means (not shown). The conductive sheets 21, 22 and the separating means are rolled to form a circular cylindrical roll, the electrode roll 20. The conductive sheets 21, 22 are coated with electrode coatings and on assembly of the cell 10, the cylindrical enclosure 11 is filled with an electrolyte. The coatings on the conductive sheets 21, 22 act as cathode and anode, respectively. The cathode, anode and electrolyte provide electrochemical energy storage. This principle is known per se, and the electrode roll 20 is commonly referred to as a jellyroll.

The conductive sheets 21, 22 of the electrode roll 20 may be axially offset in relation to one another, and each conductive sheet 21, 22 may comprise an end section that is not coated with electrode coating. Via the non-coated end sections, the respective ends of the electrode roll may be efficiently electrically connected to a current collector disc 15 or a terminal (not shown).

As is understood from FIG. 1, one of the conductive sheets 22 is arranged to be in direct electrical contact with the current collector disc 15. Direct electrical contact may be referred to as physical contact.

The cylindrical enclosure 11 further comprises a first location 23 and a second location 24 to which the lid 1 and the current collector 15 are attached, respectively. The first location 23 is axially spaced from the second location 24 along the Z-axis.

Furthermore, the lid 1 comprises a first flange 6 extending in parallel with the cylindrical enclosure 11. Further, the first flange 6 is attached to the cylindrical enclosure 11. For example, the first flange 6 is attached to the cylindrical enclosure 11 by means of welding. The flange 6 may work as the welding interface 30, and the weld seam can be inspected after weld to ensure that it is proper. The first flange 6 may be welded to the cylindrical enclosure 11 at the first location 23. The current collector disc 15 comprises a second flange 7. The second flange 7 extends in parallel with the cylindrical enclosure 11. The second flange 7 may be attached to the cylindrical enclosure 11 by means of welding. The second flange 7 may be welded to the cylindrical enclosure 11 at the second location 24. The current collector disc 15 is in direct electrical contact with the electrode roll 20, and more specifically the conductive sheet 22.

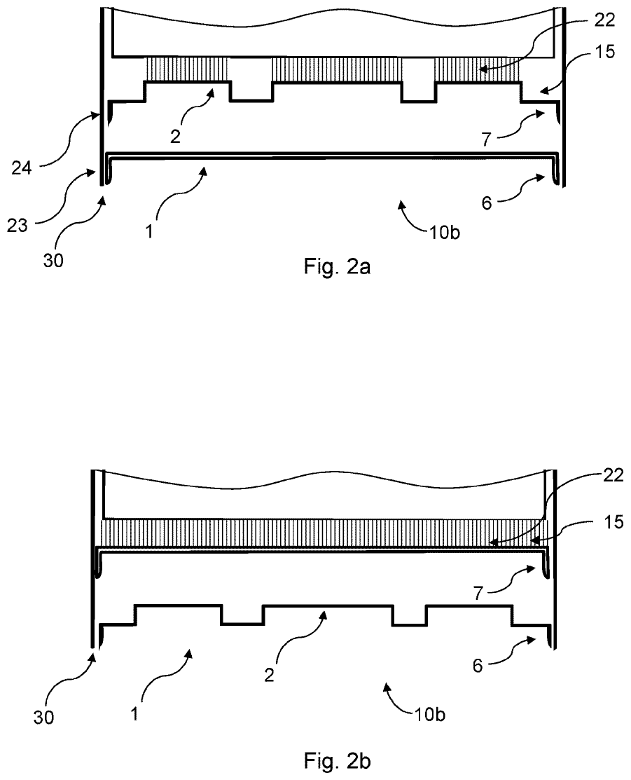

FIG. 2a shows a cross-sectional view of a portion of a cylindrical secondary cell 10 wherein a lid 1 and a current collector disc 15 are attached to a cylindrical enclosure 11. The current collector disc 15 comprises a number of recessed contact portions 2. The recessed contact portions 2 are in direct electrical contact with the electrode roll 20, and more specifically the conductive sheet 22. The lid 1 and the current collector disc 15 are arranged substantially in parallel. The first location 23 and the second location 24 are parallel with the cylindrical enclosure 11. The lid 1 is attached to the cylindrical enclosure 11 at the first location 23 by the first flange 6. The current collector disc 15 is attached to the cylindrical enclosure 11 at the second location 24 by the second flange 7. Furthermore, the welding interface 30 is visible from viewing the cell 10 from the second enclosure end 10b.

FIG. 2b shows a cross-sectional view similar to the one of FIG. 2a, however in FIG. 2b, the lid 1 comprises the recessed contact portions 2. The entire surface of the current collector disc 15 facing the electrode roll 20 is in direct electrical contact with the electrode roll 20, and more specifically the conductive sheet 22.

FIG. 3 shows a perspective view of a lid 1 with recessed contact portions 2. The recessed contact portions 2 are integral portions of the lid 1.

For example, each recessed contact portion 2 may have an area of 5 to 15 percent, or 7 to 11 percent, of the total area of the cylindrical secondary cell lid 1. With such area ranges, there may be six recessed contact portions 2.

In another example, each recessed contact portion may have an area of 10 to 30 percent, or 15 to 30 percent, of the total area of the cylindrical secondary cell lid 1. With such area ranges, there may be three recessed contact portions 2.

Preferably, the total area of the recessed contact portions 2 is 50 to 80 percent of the total area of the lid 1. Other numbers of recessed contact portions are conceivable, such as four.

The recessed contact portions 2 may be, as is shown, equidistantly distributed along the circumference of the lid 1. Such a pattern may be beneficial in assembly of the cell.

In other embodiments (not shown), not all recessed contact portions 2 are of the same size. An irregular (sizes or positioning) pattern of recessed contact portions 2 may be beneficial in manufacture, as such a pattern may facilitate vision systems identifying the orientation of the lid 1. The vision systems may be used for controlling welding apparatuses to arrange the welds at desired locations.

Each respective recessed contact portion 2 may be substantially rectangular or substantially square-shaped. More precisely, each recessed contact portion 2 may be substantially trapezoidal.

Referring to FIG. 3, the recessed contact portions 2 comprise first and second circumferential sides 2a, 2b and first and second radial sides 2c, 2d.

The first circumferential side 2a of each respective recessed contact portion 2 may extend concentrically with the lid 1. Thus, the first circumferential side 2a may be curved, more precisely arcuate or circular arcuate. The first circumferential side 2a may be positioned essentially mid-way between the outer radial end (or circumferential edge) of the lid 1 and the center of the lid. In the present example, the first circumferential side 2a extends approximately 40 to 60 degrees around the 360 degrees circumference of the lid.

The second circumferential side 2b of each respective recessed contact portion 2 may extend concentrically with the lid 1 and thus with the first circumferential side 2a. The second circumferential side 2b may be curved, more precisely arcuate or circular arcuate. The second circumferential side 2b may be positioned close to the outer radial end (or circumferential edge) of the lid 1. The distance between the second circumferential side 2b and the outer radial end may correspond to 5 to 20 percent of the radius of the lid 1, preferable approximately 15 percent. In the present example, the second circumferential side 2b extends approximately 40 to 60 degrees around the 360 degrees circumference of the lid.

As illustrated in FIG. 3, the recessed contact portions 2 are positioned closer to the outer radial end of the lid 1 than to the center of the lid 1. The first radial side 2c of the respective recessed contact portion 2 extends from a first end of the first circumferential side 2a to a first end of the second circumferential side 2b. The first radial side 2c is straight. In the present example, the first radial side extends approximately 25 to 40 percent of the radius of the lid 1. The first radial side 2c is aligned with the radial direction of the lid 1.

The second radial side 2d of the respective recessed contact portion 2 extends from a second end of the first circumferential side 2a to a second end of the second circumferential side 2b. The second radial side 2d is straight. In the present example, the second radial side extends approximately 25 to 40 percent of the radius if the lid 1. The second radial side 2d is aligned with the radial direction of the lid 1.

The sides 2a, 2b, 2c, 2d and the respective corners formed where the sides meet are rounded (radially and axially), as is shown. Thus, the transition between the recessed contact portions 2 and the surrounding area of the lid 1 can be rounded or smooth. This design is beneficial for manufacturing purposes and for reducing mechanical and electrical stress concentrations. The contact area of a recessed contact portion 2 is measured on the surface of the recessed contact portion 2 that faces the current collector disc 15.

According to FIG. 3, the lid 1 further comprises a groove or notch 4 for providing an opening in the lid 1 if a pressure to which the lid is subjected reaches a threshold value. In other words, the groove or notch 4 is to provide an opening in the lid 1 when the lid 1 is attached to the cylindrical enclosure 11, if the pressure inside the cylindrical enclosure reaches a threshold value. In such a situation, gas and/or other ejecta may be released out of the cell 10 through the opening formed in the lid 1. The opening formed in the lid 1 as a result of the groove or notch 4 breaking may be referred to as a vent opening.

The groove or notch 4, which may be referred to as a breakable portion, may be thinning of the lid material that is configured to break before other parts of the lid 1 (and the cylindrical enclosure 11). The notch 4 may be circular and may at least partly encircle a central portion of the lid 1.

1. A cylindrical secondary cell (10), comprising:
a cylindrical enclosure (11) having a sidewall (10c) and at least one open end (10b),
an electrode roll (20) arranged in the cylindrical enclosure (11), a lid (1) closing the open end of the cylindrical enclosure (10b), the lid (1) being welded to the cylindrical enclosure (11) at a first location (23), and
a current collector disc (15) arranged between the electrode roll (20) and the lid (1) and in direct electrical contact with the electrode roll (20), the current collector disc (15) being welded to the cylindrical enclosure (11) at a second location (24) separate to the first location (23).

2. The cylindrical secondary cell (10) of claim 1, wherein the lid (1) or the current collector disc (15) comprises a number of recessed contact portions (2) being 50 to 80 percent of the total area of the lid (1).

3. The cylindrical secondary cell (10) of claim 1, wherein the lid (1) and the current collector disc (15) extend substantially in parallel.

4. The cylindrical secondary cell (10) of claim 1, wherein the first location (23) and the second location (24) are axially spaced from each other.

5. The cylindrical secondary cell (10) of claim 1 wherein the lid (1) further comprises a first flange (6) to be arranged in direct electrical contact with the cylindrical enclosure (11) of the cylindrical secondary cell (10).

6. The cylindrical secondary cell (10) of claim 5, wherein the lid (1) is configured to be attached to the cylindrical enclosure (11) solely by a welding between the first flange (6) and the cylindrical enclosure (11).

7. The cylindrical secondary cell (1) of claim 6, wherein the first flange (6) and the cylindrical enclosure (11) extend substantially in parallel.

8. The cylindrical secondary cell (10) of claim 1, wherein a weld interface (30) between the cylindrical enclosure (11) and the lid (1), after welding, is at least partly visible such that the weld may be inspected.

9. The cylindrical secondary cell (10) of claim 1, wherein the current collector disc (15) further comprises a second flange (7) to be arranged in direct electrical contact with the cylindrical enclosure (11) of the cylindrical secondary cell (10).

10. The cylindrical secondary cell (10) of claim 9, wherein
the number of recessed contact portions (2) are on the current collector disc (15), and
the number of recessed contact portions (2) are arranged in direct electrical contact with the electrode roll (20) arranged inside the cylindrical secondary cell (10).

11. A method of manufacturing the cylindrical secondary cell (10) of claim 1, the method comprising:
arranging the current collector disc (15) in direct electrical contact with the electrode roll (20),
welding the current collector disc (15) to the cylindrical enclosure (11), arranging the lid (1) in the cylindrical enclosure (11),
welding the lid (1) to the cylindrical enclosure (11).

12. The cylindrical secondary cell (10) of claim 2, wherein the lid (1) and the current collector disc (15) extend substantially in parallel.

13. The cylindrical secondary cell (10) of claim 12, wherein the first location (23) and the second location (24) are axially spaced from each other.

14. The cylindrical secondary cell (10) of claim 12, wherein the lid (1) further comprises a first flange (6) to be arranged in direct electrical contact with the cylindrical enclosure (11) of the cylindrical secondary cell (10).

15. The cylindrical secondary cell (10) of claim 14, wherein the lid (1) is configured to be attached to the cylindrical enclosure (11) solely by a welding between the first flange (6) and the cylindrical enclosure (11).

16. The cylindrical secondary cell (1) of claim 15, wherein the first flange (6) and the cylindrical enclosure (11) extend substantially in parallel.

17. The cylindrical secondary cell (10) of claim 12, wherein a weld interface (30) between the cylindrical enclosure (11) and the lid (1), after welding, is at least partly visible such that the weld may be inspected.

18. The cylindrical secondary cell (10) of claim 12, wherein the current collector disc (15) further comprises a second flange (7) to be arranged in direct electrical contact with the cylindrical enclosure (11) of the cylindrical secondary cell (10).

19. The cylindrical secondary cell (10) of claim 18, wherein:
the number of recessed contact portions (2) are on the current collector disc (15), and
the number of recessed contact portions (2) are arranged in direct electrical contact with the electrode roll (20) arranged inside the cylindrical secondary cell (10).
